(19) United States
(12) Patent Application Publication
(10) Pub. No.: US 2002/0099571 A1
(43) Pub. Date: Jul. 25, 2002

(54) System and method for management of various works in hospitals

(76) Inventors: Toshiya Waku, Otawara-shi (JP); Daizo Oikawa, Otawara-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/040,628

(22) Filed: Jan. 9, 2002

(30) Foreign Application Priority Data
Jan. 10, 2001 (JP) 2001-003039

(51) Int. Cl. G06F 17/60

(52) U.S. Cl. 705/2

(57) ABSTRACT

There is disclosed a medical management system which generally manages an operation situation of each apparatus by a mode called a the, and manages a flow of all medical works executed by the system in executing the medical work relating to a patient in the system as an object.

### CROSS-REFERENCE TO RELATED APPLICATIONS

This application is based upon and claims the benefit of priority from the prior Japanese Patent Application No. 2001-3039, filed Jan. 10, 2001, the entire contents of which are incorporated herein by reference.

### BACKGROUND OF THE INVENTION

1. Field of the Invention

The present invention relates to a work management system and method by utilizing a network to accomplish overall management of the operations performed by apparatuses in medical works, such as image diagnostic apparatuses utilizing X-ray, X-ray CT, magnetic resonance, nuclear medicine, and ultrasonics, as well as medical image processing apparatuses, medical workstations, and medical information apparatuses.

2. Description of the Related Art

In recent years, innovations in medical techniques have closely followed those of the information technology field. For example, new diagnostic information is provided, more delicate surgery is made possible, the quality of surgery, as a service, is enhanced, the efficiency of the various works medical work performed in a medical institution including a medical work and medical office work are enhanced, and many other allied fields are influenced in this manner.

Concretely, examples of techniques for providing new diagnostic information and facilitating detailed medical procedures include various image diagnostic apparatus (X-ray diagnostic apparatus, X-ray CT apparatus, magnetic resonance diagnostic apparatus, nuclear medicine diagnostic apparatus and ultrasonic diagnostic apparatus), ultrasonic treatment apparatuses, and the like.

Moreover, examples of techniques for enhancing the efficiency of the business side of the medical industries include a system for general information management. Typical examples thereof include a hospital information system (hereinafter referred to as “HIS”), for generally managing business information in a hospital, a radiology information system (hereinafter referred to as “RIS”) for generally managing medical information in a radiation section, and the like.

Furthermore, the enhancement of efficiency of the medical procedures is realized by introducing information techniques such as in-hospital LANs, and medical workstations.

However, in recent years, the influence on medical fields has caused the following problems.

Firstly, many information apparatuses which have been of a great variety are introduced. In general, systems of various makers have been introduced. However, even when the system is constituted of products from the same maker, operability of the respective apparatuses is not unified in many cases. Therefore, the operation of the apparatus requires much time, and there is a risk of malfunction. There is also the problem that an operation method learning time is long at a time of introduction of a new apparatus or addition of a new member. Particularly, when users such as a doctor and engineer learn operation methods of a great variety of apparatuses, imposed burdens can be said to be large.

Secondly, the techniques represented by HIS and RIS are limited by the respective apparatuses or a processing in one apparatus. Therefore, the technique does not enable total management in a network environment inside and outside the hospital and section and can not provide meaning of automation, power saving, overall system awareness or the like on a more global level. Particularly in a conventional technique, there is no structure for transferring operations between apparatuses, or for enabling parallel processing. Therefore, it is unavoidable that the globalization of the system according to only the conventional technique causes a problem of generation of a double operation in the individual apparatuses or the like.

The present invention has been developed in consideration of the aforementioned circumstances, and an object thereof is to provide a medical work management system which can easily be operated by a user, and which can quickly provide information so as to appropriately and easily grasp a stream of various works performed in a global medical system using medical work not only a single apparatus but also a plurality of apparatuses, and a medical work management method.

### BRIEF SUMMARY OF THE INVENTION

To achieve this object, according to an aspect of the present invention, there is provided a system to be connected via a network to a plurality of medical systems installed in a medical institution, configured to manage various works performed at the medical systems, the system comprising: a memory which stores information items relating to work processes performed in the medical systems, each item representing the sequence and conditions of one work process relating to one patient or one medical examination; an information-updating processor which updates the information item stored in the memory to one that represents the present state of the work process; and a transmitter which transmits display information to the medical systems through the network, the display information causing the medical system to display the information items updated on the present state of each of the work processes in such a display mode as to represent the present state of each of the work process relating to one patient or one medical examination.

According to this configuration, a medical work management system which can easily be operated by a user and which can quickly provide information so as to appropriately and easily grasp a flow of a medical work in a global system involving a plurality of apparatuses can be realized.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block constitution diagram of a stream control module of a whole control type.

FIGS. 2, 3 show block constitution diagrams of the stream control module of a processing dispersion type.

FIG. 4 shows an example of a console screen in which a stream list defining a flow of a medical work of a CT examination of a radiation section is displayed.

FIG. 5 shows another example of the console screen in which the stream list defining the stream of the medical work of a CT examination of the radiation section is displayed.

FIG. 6 is a diagram showing a modification example of the present medical work management system.

FIG. 7 is a diagram showing an example in which a medical work management system of the present invention is applied to the radiation section.

FIG. 8 is a diagram showing an example in which the present medical work management system is applied to the radiation section.

FIG. 9 is a diagram showing an example in which the present medical work management system is applied to the radiation section.

FIG. 10 is a diagram showing an example in which the present medical work management system is applied to the radiation section.

FIG. 11 is a diagram showing an example in which the present medical work management system is applied to the radiation section.

FIG. 12 is a diagram showing a system example in which one stream control module is installed in a hospital and a stream of the hospital as a whole is controlled.

FIG. 13 is a diagram showing a system example of a constitution in which a sub module for managing a section is installed.

FIG. 14 is a diagram showing an example in which a sub stream is controlled in a CT apparatus and a process is controlled in a workstation.

FIG. 15 schematically shows a flow of an outpatient and data in the hospital when the present medical work management system is applied in the hospital and the medical work is performed in accordance with a stream.

FIG. 16 shows an example in which the present medical work management system is applied to a plurality of hospitals.

### DETAILED DESCRIPTION OF THE INVENTION

An embodiment of the present invention will be described with reference to the drawings. Additionally, in the following description, elements having substantially the same function and constitution are denoted with the same reference numerals to avoid repetition, and a description is given only when necessary.

One important aspect of a medical work management system according to the present embodiment lies in the idea that the operational status of each apparatus is generally managed by a mode called a “stream” in order to execute a medical work relating to a patient in a system as an object, and thereby the flow of all medical works executed in the system is managed.

(Stream)

The stream has been developed to grasp/manage a flow of the various works of a whole medical network system as an object based on an operation of a computer or a medical apparatus having a computer function, and is defined by arranging a predetermined work unit called a “process” in a predetermined order (e.g., an order of implementation ). The stream defines the flow of the works in a section or a hospital as a management object, or between the hospitals (hereinafter, a work performed in a medical institution is referred to as a medical work). Any means, such as a format or script, can be used, but can be applied not only to the single apparatus but to a plurality of apparatuses. Assuming that the stream is applied to a network system constituted of a network of one medical examination section and apparatuses connected to the network, the stream is defined by a plurality of work units planned to be implemented, such as patient registration, scanning, reconstruction, image processing, filming, and archiving. Additionally, when one medical work is to be implemented, the stream is sometimes constituted by a single process. Moreover, a process is a predetermined work unit, and the content does not have to indicate a single work. For example, when all composite operations, such as reconstruction, image processing, filming, and archiving are performed, the process of “diagnostic image generation” can be defined.

Various systems for the management of the medical work as an object by the stream are considered. Examples include a system for executing medical works relating to a plurality of patients in parallel, in a single apparatus; a global system which uses the network and a plurality of apparatuses inside and outside the hospital, and the like. The application to various systems will be described later in respective embodiments.

In the present medical work management system, the scheduling of medical works, operation of connected apparatuses, and the like are one-dimensionally managed. This is realized by a stream control module described hereinafter.

(Stream Control Module)

For management of medical works using the stream, when the stream control module for managing the stream is disposed, any apparatus based on an engineering workstation, including an electronic calculator and personal computer can be managed.

As described later in the respective embodiments, the stream control module utilizes the network to perform information management relating to a medical work system established in a predetermined region, such as a plurality of hospitals, inside the hospital, and examination section. Examples of installation of a stream control module in the system are a “whole control” type and a “dispersion” type.

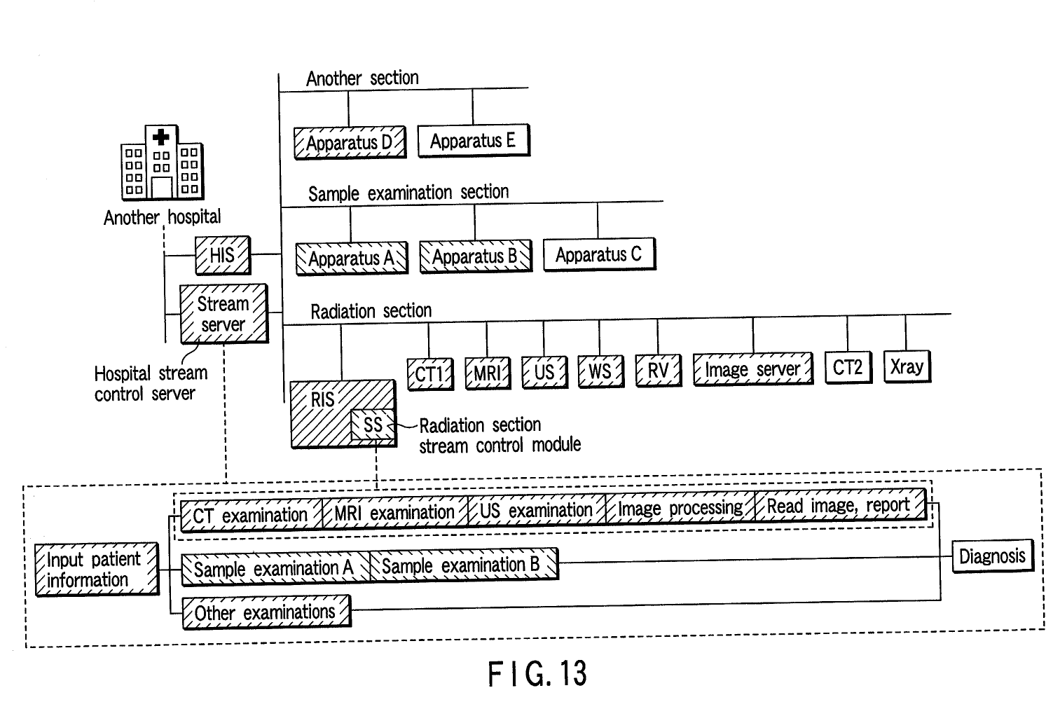

The whole control type is a mode in which general information management of the medical work system for each predetermined level unit, such as a hospital, examination section, or diagnostic apparatus is performed. In this mode, shared information to be managed is concentrated on an upper-level control module. The whole control type can be applied, for example, to a system described later and shown in FIG. 13. That is, in the stream of the whole hospital, the image diagnostic examination, as a sub stream of a radiation section in the whole stream, is controlled not by a stream server of the whole hospital, but by a stream server for controlling the stream in the radiation section, in the example. Moreover, when individual apparatuses perform a plurality of processes, sub stream modules are installed in the apparatuses, and in the example a nested stream can be constituted, such as a whole hospital stream, radiation section stream, and CT apparatus stream.

On the other hand, in the dispersion type, only specific information (e.g., control, display, and operation of a progress state of the process) is managed in a medical work system scale, and other information (e.g., control, display, and operation of the process for each section) is managed by the individual apparatuses. In this mode, each of the terminals controls the execution of the processes in the inside of self-equipment and transmits information of starting or completing a process to the stream server managing the whole system. The stream server controls the stream of the whole system, reflecting the information of starting or completing the process and transmits the latest stream information to each of the terminals.

These stream control modules may be incorporated in the existing apparatus, or may be installed as an independent exclusive-use server on the system. The constitution is mainly applied to a system in which the network is utilized to manage the operations of a plurality of apparatuses. In this case, the module is sometimes referred to as a stream control server. Respective embodiments described later include: an example in which an independent stream control module (stream control server) is installed and the stream of the whole hospital is controlled; an example in which a sub module for managing the inside of the section is installed and the stream is controlled in the section; an example in which a global stream control module is installed in one hospital, a local stream control module is installed in another hospital, and template management or stream management is performed in a transverse manner among a plurality of hospitals; and the like.

Additionally, whether the stream control function is incorporated in the existing apparatus or an exclusive-use server is disposed is decided according to the scale and range of the apparatus used, number of examinations, processing ability of the apparatus, cost, and the like.

(Constitution of a Stream Control Module)

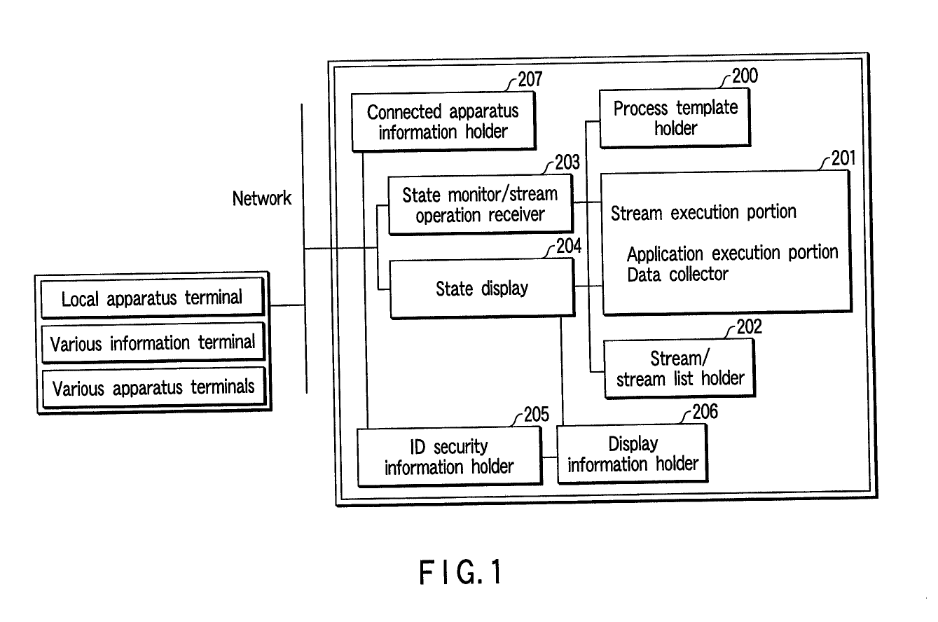

First, a block constitution of the stream control module disposed in a system according to the present embodiment will first be described with reference to FIG. 1.

FIG. 1 is a block constitution diagram of a stream control module 20 of the whole control type.

The stream control module 20 includes a stream template holder 200, stream execution portion 201, stream/stream list holder 202, state monitor/stream operation receiver 203, state display 204, ID security information holder 205, display information holder 206, and connected apparatus information holder 207.

The stream template holder 200 stores a stream template relating to all the apparatuses controlled by the stream control module 20 in response to a request from the apparatus. Here, the stream template is the stream formed in a template (fixed format) for each of types (such as a case, diagnostic site, operator, patient, image reader or observer, examination apparatus, image reader apparatus or image apparatus, and medical association).

Moreover, the stream template holder 200 holds the template for each process in the stream template.

Here, the template for each process will be described. The process indicates a processing unit such as scanning, image processing, and filming in an example of CT examination. The stream defines a flow and connection of these processing units. In each process, in scanning, for example, the present company has automated scanning and template called an expert plan. The scanning plate can be stored/selected as the template in accordance with a body type and case of the patient. In the filming, auto filming is prepared as the template for each process. In the image processing, a 3D template is prepared for each process in the conventional technique. The stream of the present invention can not only define the flow of the process but also store the process template for use in each process and parameters for use in the template. Therefore, according to the stream prepared in an appropriate content, the examination can be performed with total automation or semi automation (merely by pressing the “OK button” and “next button” at a division of the processing). For example, in the stream of a simple head CT examination, an adult simple head scan template is set in a scanning/reconstruction process, a coronal MPR batch processing template is set in the image processing process, and a template of two 5×4 frames is set in the filming process.

The stream execution portion 201 is a controller for automatically executing the selected stream, and mainly executes a processing requiring no dialogue operation in the stream to be executed. Moreover, to execute a plurality of streams in parallel, the stream execution portion 201 exclusively allots the process into an apparatus (hereinafter referred to as an “exclusive processing”) based on the information stored in the connected apparatus information holder 207 and time information, and executes the process so that the predetermined process does not interfere with another process in the predetermined apparatus.

The stream execution portion 203 comprises an application execution portion and a data acquisition portion. The application execution portion executes applications corresponding to the various processes. The data acquisition portion acquires data from each of the terminals via a network.

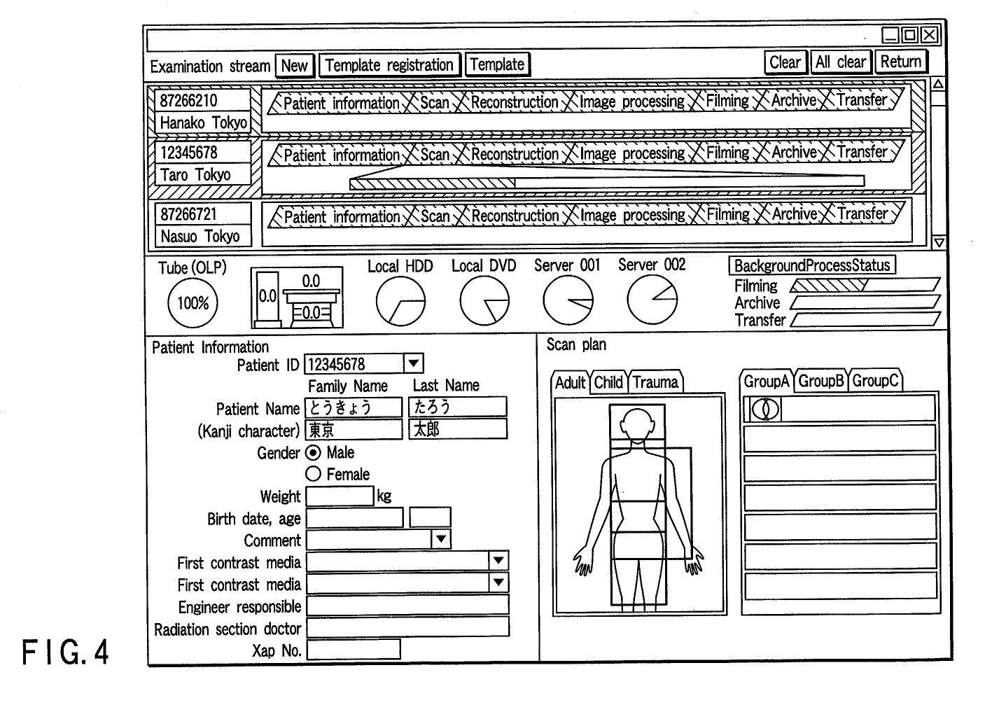

The stream/stream list holder 202 is a storage for storing the stream of all the apparatuses controlled by the stream control module 20. Here, for example, as shown in FIG. 4, the stream list is constituted by arranging the streams for the respective patients in parallel, in a predetermined order (in an order of reception in FIG. 4), so that the general progress situation of the medical work is managed.

The state monitor/stream operation receiver 203 receives information relating to the operation, such as an operation request with respect to the stream performed in all the apparatuses controlled by the module 20, and sends the information to associated functional blocks (e.g., respective constituting elements of the module 20). Moreover, the state monitor/stream operation receiver 203 obtains state information from an apparatus which does not automatically transmit updated information to the module 20 at a predetermined timing.

The state display 204 transmits latest information of the state of the stream changed by reflecting the operation request received by the state monitor/stream operation receiver 203 by the stream execution portion 201 to all the apparatuses controlled by the module 20.

The ID security information holder 205 stores information for performing restrictions on operation/display for a purpose of security by an individual or group unit with respect to all the apparatuses controlled by the module 20. Moreover, the ID security information holder 205 newly stores the transmitted content when there is a transmission for registration, change, deletion, and the like associated with the security from the respective apparatuses on the system.

The stream execution portion 201 specifies the information on the stream for each system based on the information in the ID security information holder 205. For example, when there is a stream preparation request (described later) from the predetermined apparatus on the system developed in the predetermined section, the stream execution portion 201 executes ID check based on the information in the ID security information holder 205, and selects and transmits the information for the predetermined system and apparatus.

Additionally, the module 20 regards the security as important according to the constitution, so that information relating to a plurality of one-dimensionally managed apparatuses, or information relating to a plurality of groups is prevented from leaking outside the system as the object.

The display information holder 206 stores a display content for each individual, group, or apparatus. The information stored in the display information holder 206 is used in filter display of the stream list as described later. Moreover, when each apparatus transmits a request for registration, change, or deletion in a display method, the display information holder 206 newly stores the transmitted content.

The connected apparatus information holder 207 stores information inherent to all the apparatuses controlled by the module 20. To control various connected apparatuses in accordance with the stream, or perform parallel processing of the stream, the stream execution portion 201 manages each stream and controls the connected apparatus based on the information stored in the connected apparatus information holder 207 so that redundancy is not generated among the streams.

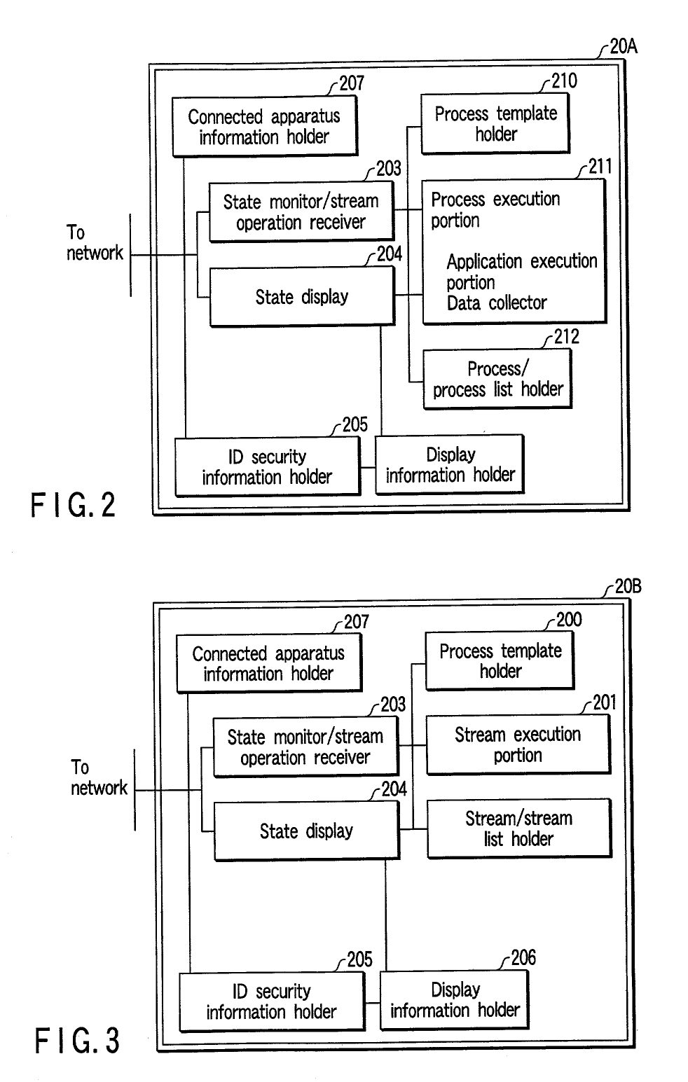

FIG. 2 is a block constitution diagram of a stream control module 20 of the dispersion type. As shown in FIG. 2, stream control module 20A is installed in each of the terminals and executes individual processes in the inside of each of the terminals. The function of each composition is as follows.

The stream template holder 210 holds the template for each process in the stream template (process template).

The process execution portion 211 is a controller for automatically executing the selected process, and mainly executes a processing requiring no dialogue operation in the process to be executed. Moreover, to execute a plurality of processes in parallel, the process execution portion 211 exclusively allots the process into apparatus based on the information stored in the connected apparatus information holder 207 and time information, and executes the process so that the predetermined process does not interfere with another process in the predetermined apparatus.

The process/process list holder 212 is a storage for storing the processes of all the apparatuses controlled by the stream control module 20A. Here, for example, the process list is constituted by arranging the process for the respective patients in parallel in a predetermined order, so that the general progress situation of the medical work is managed.

The state monitor/stream operation receiver 203 receives information relating to the operation, such as an operation request with respect to the stream performed in all the apparatuses controlled by the module 20A, and sends the information to associated functional blocks (e.g., respective constituting elements of the module 20A). Moreover, the state monitor/stream operation receiver 203 obtains state information from an apparatus which does not automatically transmit updated information to the module 20B at a predetermined timing.

The state display 204 transmits latest information of the state of the stream changed by reflecting the operation request received by the state monitor/stream operation receiver 203 to all the apparatuses controlled by the module 20.

The display information holder 206 stores the display content for each individual, group, or apparatus. The information stored in the display information holder 206 is used in filter display of the stream list as described later.

The connected apparatus information holder 207 stores information inherent to all the apparatuses controlled by the module 20. To control various connected apparatuses in accordance with the stream, or perform parallel processing of the process, the stream execution portion 201 manages each process and controls the connected apparatus based on the information stored in the connected apparatus information holder 207 so that redundancy is not generated among the processes.

Note that, the stream control module 20B is located on a higher-level than the control module 20A and manages the stream of the system scale. The configuration of the stream control module 20B is substantially the same as the control module 20, as shown in FIG. 1. The stream control module 20B receives information with respect to the starting or completing of the process or the like form the control module 20A installed in each of the terminal and updates the stream according to the information.

(Function of Stream Control Module)

Each of the stream control modules 20, 20A, and 20B typically have two functions. One is a stream template management function, and the other is a stream execution management function. Hereinafter, the stream control module 20 is explained as an example.

The stream template management function is a function for performing management of new preparation, referring, changing, and duplication of the stream template. Here, for the new preparation of the stream template, the stream of each predetermined item (such as the case, site, operator, patient type, image reader, examination apparatus, and image reader apparatus) is newly formed in the template. The newly prepared stream template is registered/stored, and can be read from the terminal on the network at an arbitrary timing. Stream referring (selective reading) is a processing for selecting the template for use, when stream execution is started. Stream changing is a processing for changing the content of the selectively read template at an arbitrary timing. New preparation, referring, changing, and duplication of the stream template can be executed from any apparatus on the network at any time.

The stream template management function is executed mainly by the state monitor/stream operation receiver 203, stream template holder 200, and stream execution portion 201 of the stream control module 20. That is, the state monitor/stream operation receiver 203 receives the stream template newly prepared or changed by the apparatus on the network, and stores the template in the stream template holder 200. Moreover, to refer to the stream, the stream execution portion 201 reads the stream template holder 200 in the stream control module 20, and the state monitor/stream operation receiver 203 transmits the stream to the apparatus having transmitted the request on the network.

Additionally, storage of the stream or the stream template is not limited to the stream template holder 200 in the module 20, and may also be stored in a local apparatus, associated system apparatus, removable media, and server (image server, HIS/RIS server, WWW server, and the like). That is, the object can be achieved in a constitution in which the stream or the template can be shared, duplicated, or sold in the hospital or among the hospitals.

Additionally, the stream or the stream template in the stream template holder 200 can be accessed from anywhere on the network, in principle. However, the module 20 can set access rights, from the viewpoint of security. This is realized by the ID security information holder 205.

Moreover, the changed/modified stream template can spread changed/modified content over the whole system. This is achieved by latest transmission to each connected apparatus by the state display 204. Furthermore, the stream or the stream template can be shared and the processing can be transferred among the apparatuses connected via the network. This is possible because the module 20 one-dimensionally manages the information relating to the medical work. Additionally, when the new processing is transferred, it is preferable that the state just before receiving the transferred processing can be reproduced in the apparatus having the transferred processing.

On the other hand, in stream execution management, the operation of each apparatus on the network is managed/controlled in accordance with the stream. This function concretely realizes the following processing.

(1 ) Providing Information relating to the Progress Situation of a Stream

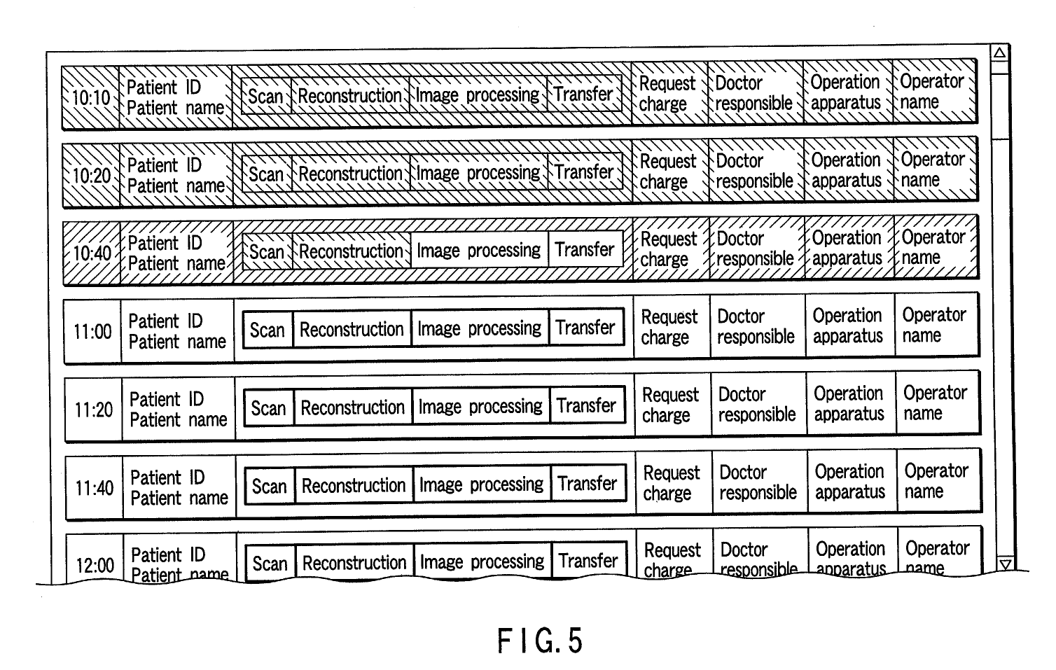

In order to easily confirm a progress degree of the stream in each apparatus connected to the network, information by which the progress situation of the stream can be judged. For example, when the plurality of apparatuses as the objects are controlled by the stream, the information indicating the apparatus (place), time (time information), and progress degree of the medical work (progress situation) is provided. The information is realized, when the state display 204 transmits the latest information of the medical work in accordance with the stream to each apparatus on the network. In each apparatus, for example, as shown in FIG. 4 or 5, the stream is displayed in a list in a mode in which the progress situation can be judged (e.g., in a display in which respective examined, executing, and reserved (waiting for the examination) states can easily be seen).

FIG. 4 shows an example of a console screen in which the stream list defining the flow of the medical work of CT examination of the radiation section is displayed. There are displayed buttons for newly registering an examination stream, registering the stream as the template, reading the template, clearing the stream, clearing all, and returning to the start (canceling the operation), and the operation is performed with respect to the template.

Moreover, the stream can be listed or operated with an examination stream list. Here, the stream for one day in the CT apparatus is displayed. The screen is scrolled with a right-side scroll bar so that all the examinations can be seen.

In the list display, examined (normal end, abnormal end), examining, and examination reserved states can be confirmed. Here, the examined state is displayed in green, the examining state is displayed in yellow, and the examination reserved state is displayed in white. The state is displayed by classification by color in this manner. Furthermore, in the stream being examined, the color is also classified for each process, the executed process is displayed in green, the process being executed is displayed in red, and the non-executed process is displayed in white.

In a patient information input process, the obtained information is displayed, and further, additional information can be inputted. In this example of the stream, the patient information input, scanning, reconstruction, image processing, filming, archiving, and transfer processes are performed in order. To shift to the next scanning process from the patient information input, the “next button” (not shown in FIG. 4) or “scan” process button of the stream list is depressed.

The content of the stream differs with the hospital, patient type, site, case, operator, emergency case, and the like. Even in such a complicated examination procedure, the operator simply confirms the stream in the stream list, designates the stream, or designates “next”.

Moreover, in the example of FIG. 4, the progress situation of each process can be displayed.

The state of the CT apparatus and situation of the connected apparatus are displayed in the stream list of FIG. 4. Here, from a left side, an OLP state of an X-ray tube, CT scanner base, situation of a bed, hard disk capacity, removable media capacity, hard disk of the server, or a removable media capacity, and a background processing such as a filming processing, archiving processing, and transfer processing are displayed. When a background process status button is depressed, detailed display of the individual background processings, and a cancel processing can be performed. A dialogue appears.

In various situations display, patient/examination information, and a detailed panel of each process are displayed. In the patient/examination information display, information obtained from the HIS/RIS is displayed, and information is also manually inputted. Moreover, to prevent erroneous input, the automatically obtained information, and information inputted in the apparatus can be displayed by distinguishing font and color.

Input, selected item, processing result, and the like in each process are displayed in each process display area. FIG. 4 shows a scan process example in which a scan template selection screen is displayed. The template defined beforehand when the stream is defined is automatically displayed, and can be changed at a time of starting/executing the process.

FIG. 5 shows another display example of the stream list.

This is an example in which display of the examinations scheduled for the CT apparatus in one day, and examination stream management are simultaneously performed. Usually, an examination time schedule table is browsed and checked by an HIS/RIS terminal or paper. However, in this display form, it is unnecessary to confirm the schedule by the HIS/RIS terminal and paper.

As described with reference to FIG. 4, the states such as the examined, examining, and examination reserved states can be distinguished using colors. In the example, only the processes of scan, reconstruction, image processing, and image transfer in the CT apparatus are displayed. An examination scheduled time, requested section, doctor responsible, apparatus name, and operator are also set for displaying. This list can be displayed not only in the HIS/RIS but also in the CT apparatus and workstation. Additionally, in addition to the examination scheduled time, times such as an examination end time and required examination time can also be displayed.

Additionally, for example, the screen in which the stream list is displayed can have the following display modes.

(i) An operating person or a person to operate is inputted or displayed.

(ii) An unperformed processing, wait state of resource, generation of a problem, and the like are displayed.

(iii) A normal end or an abnormal end can be distinguished in the display.

(iv) The state/situation associated with the stream, such as the state of the local apparatus or the network apparatus is displayed.

(v) An order of priority is designated and displayed by a stream or process unit.

(vi) The stream distinguished or filtered for each operator, apparatus, process, image reader, examination room, and the like is displayed with customization (refer to (2) “Display Filter” described later).

(vii) A prescription content and parameter of the process are display beforehand, before the process is executed.

(viii) The display of the situation of the processing associated with the stream: the progress state of the processing such as a foreground processing and background processing is displayed.

(ix) A wait state of OLP, base position, angle, HDD capacity, removable media capacity, and the like are displayed.

Moreover, in the present system, the directions for performing the various processes managed by the stream manages can be inputted from the terminal screen displaying the stream list.

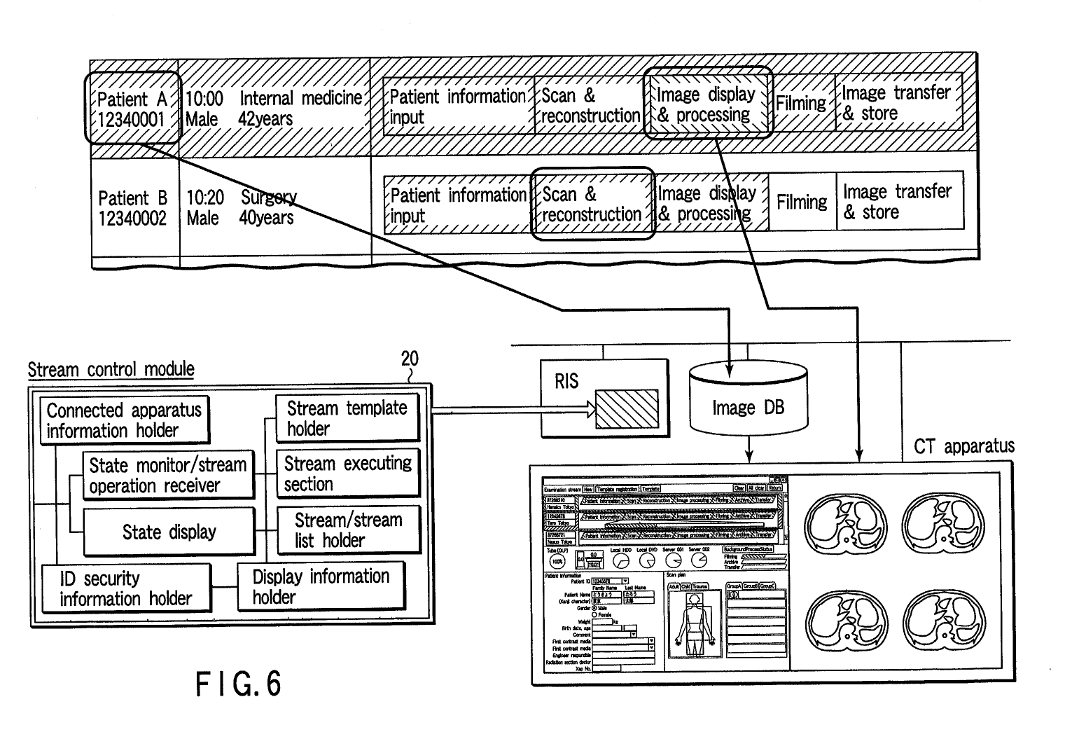

That is, with the stream display and operation means of the present system, a desired operation can be performed only by selecting the desired processing from the stream (examination) list. In an example of FIG. 6, when a scan processing is performed for a patient D on the CT apparatus, an image of a patient A of three examinations before is displayed. In this case, when an image display process button on the stream of the patient A is depressed, input signal is received by the state monitor/stream operation receiver 203 in the module. The stream execution portion 201 readouts the image stored in the DB on the network and transfers the image to the terminal. The terminal displays the image of the patient A on the basis of the received imaging data. Therefore, when an image display process button on the stream of the patient A is just depressed, the application changes to an image display application, and the image of the patient A is automatically loaded in the application.

Moreover, when a scan process button of a patient D is depressed, the process can be returned to the original process being executed. Even when another processing is performed in a critical processing, such as a scan processing, the interrupt processing can be performed with a simple operation.

In diagnostic imaging apparatus, image processing systems, etc., when the image which is not currently being processing and which it is not, for example, the image acquired at an previous examination, was displayed and processed, in the conventional technique, execution application was started and the step of choosing the desired image from the image list after that was stepped on. On the other hand, according to the above-mentioned configuration, since the desired work can be executed only by choosing desired processing from the stream (examination), a user-friendly system which enables work to be carried out efficiently is provided.

(2) Display Filter

The stream list may define a broad-range flow of the medical work. In this case, for example, in a certain section, it is unnecessary to display the process of another section in many cases. In consideration of this, the present system has a display filter function, making it possible to control the display content for each predetermined division. Additionally, this display filter function is realized by selecting the information to be transmitted to each apparatus by the state display 204 in accordance with the content of the display information holder 206.

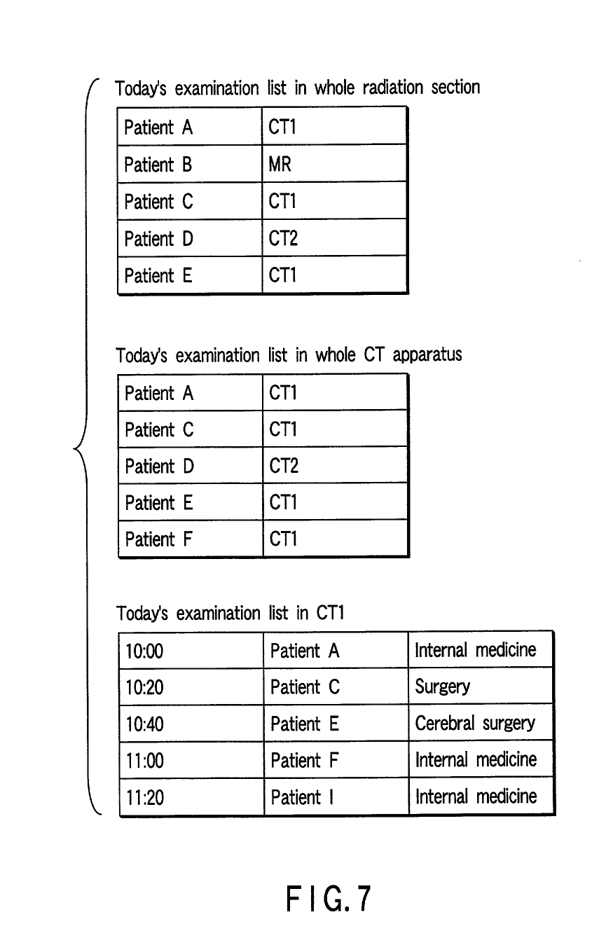

FIG. 7 is an explanatory diagram showing a function for limiting the display by a display filter, and shows display information in the predetermined division held by the display information holder 206. As shown in FIG. 7, when the display filter is changed for the whole section, a plurality of CT apparatuses, the whole hospital, or a plurality of hospitals, the list can be browsed and operated by various divisions. Moreover, when a new division and the corresponding display item are defined, the display content can be edited for each apparatus. Additionally, newly defined, changed, or updated display information is stored in the display information holder 206.

The following are examples of divisions of the display information:

(i) Requested section, hospital

(ii) Patient (including a previous medical examination result)

(iii) Time, day

(iv) Doctor responsible

(v) Examination room, ward

(vi) Image reader doctor

(3) Waiting for Request to Module 20 and State Monitoring

Since the operation procedure over a composite area is generally controlled, the module 20 monitors the states of all the apparatuses in the system. Concretely, the state monitor/stream operation receiver 203 manages generated event information in a centralized manner. When the receiver 203 receives an event generated in a predetermined apparatus, the stream execution portion 201 rewrites (changes) the stream with the event reflected therein. The state display 204 transmits the changed content to each apparatus on the network.

(4) Stream Operation

In each apparatus on the network, the stream and stream list are not only displayed but also operated. Inputting in each apparatus on the network in order to execute the content of the existing stream is called a stream operation. For example, when the stream or the process on the screen is clicked, the corresponding processing is performed. For the stream list, each item can be manually inputted at a CT console, HIS/RIS terminal, image processing workstation, image reading workstation, and the like. Alternatively, patient information, examination order, past information, and the like can be collectively or individually obtained from a hospital/section/patient information system, such as HIS/RIS. Additionally, each of the following operations can be carried out in each apparatus on the network. Moreover, in each apparatus, the operation executed with respect to the stream is received by the receiver 203 as described in the above (2), and reflected in the existing stream or the stream list.

(i) Re-performing or returning can be instructed or executed with respect to the ended stream or process.

(ii) The processing such as image browsing can be performed in parallel without influencing the processing of the stream or the process.

(iii) An approval waiting command can be disposed in a division of the stream or the process.

(iv) Since the stream or the process is selected, it is unnecessary to use a file list.

(v) An order of the stream or the process is changed. For example, temporary stop, stop, and pass can be instructed with respect to the stream or the process.

(vi) The stream is deleted or added.

(vii) An operation other than the defined operation can be performed in an interrupt manner during execution of the stream.

(viii) An interrupt processing is performed, and after end of the processing the interrupted state easily returns to the original state.

(ix) A plurality of streams can be simultaneously executed in individual apparatuses or in the whole system.

### Example 1

A first embodiment of medical work management by the aforementioned system will be described.

First, the embodiment of the medical work management in accordance with the stream of a single section, such as the radiation section, will be described.

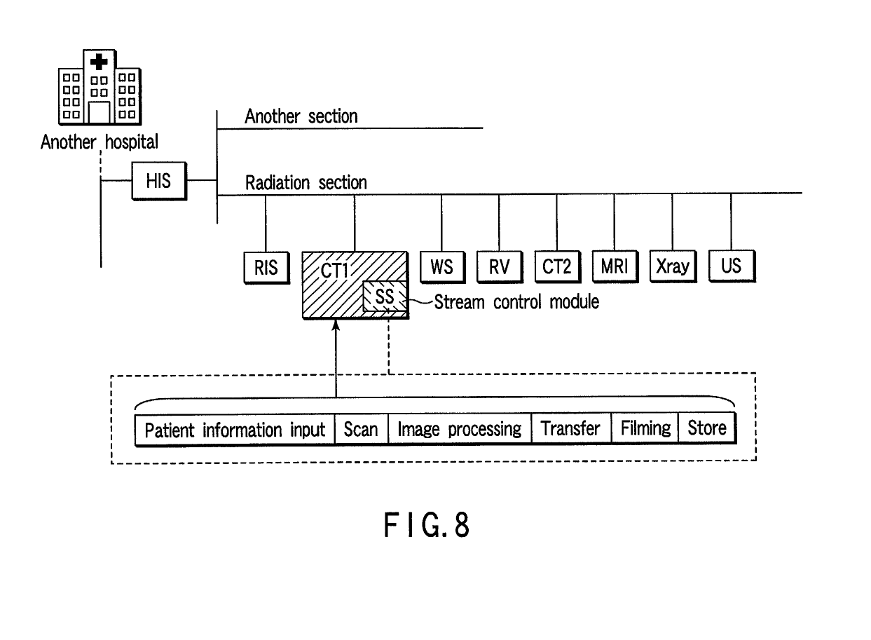

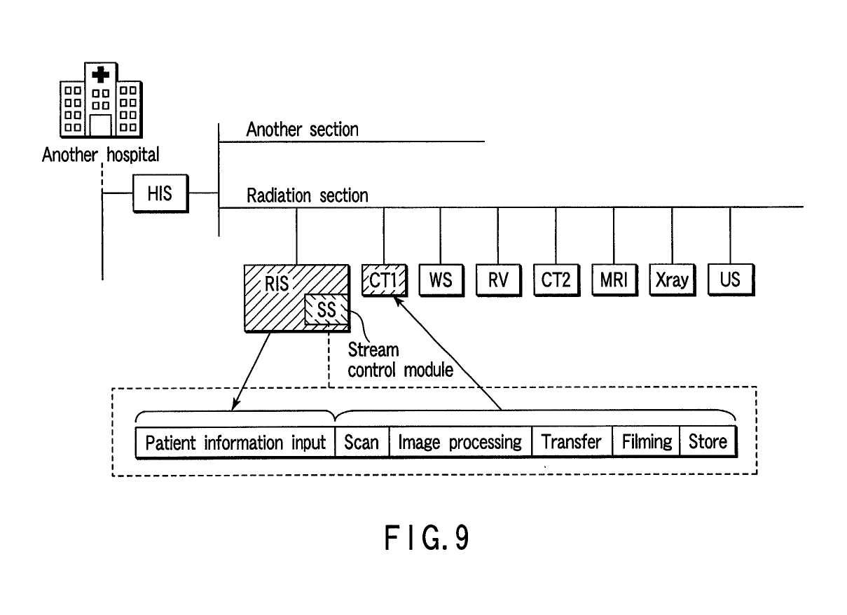

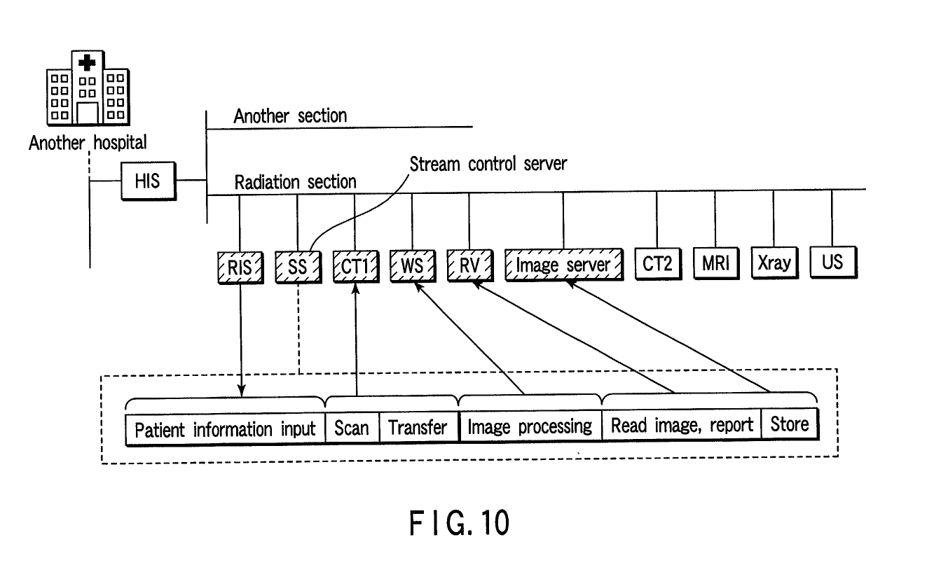

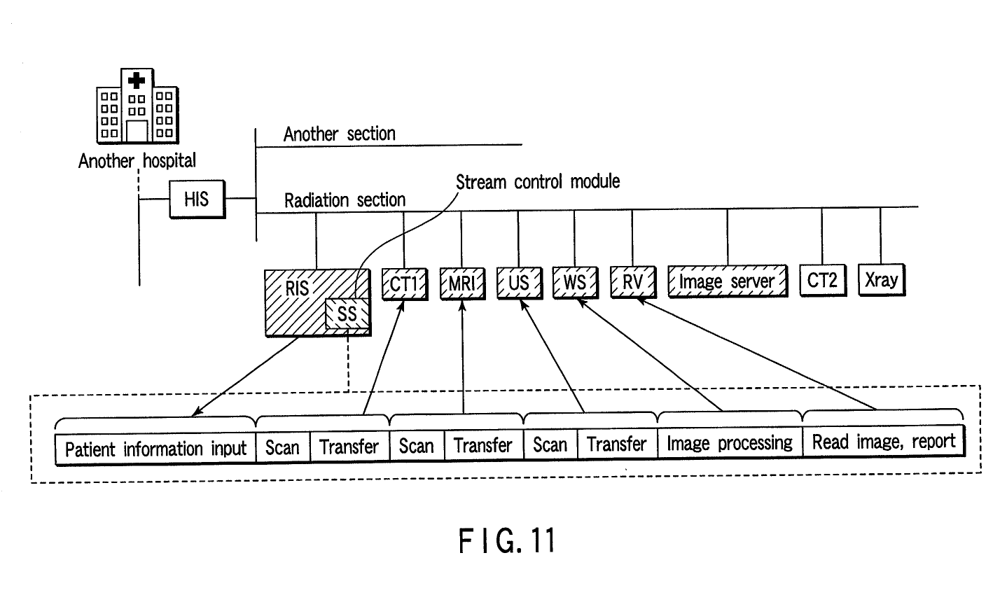

FIGS. 8 to 11 are diagrams showing examples in which the present medical work management system is applied to the radiation section. Additionally, the system shown in FIG. 9 and 11 covers the patient/ examination information of the whole radiation section in RIS. In the RIS, the examination stream is prepared, and a patient information input process is performed. Moreover, the system shown in FIG. 8 is constituted by mounting the stream control module 20 in CT1, and the system shown in FIG. 10 is constituted by disposing the stream control module 20 as the stream control server.

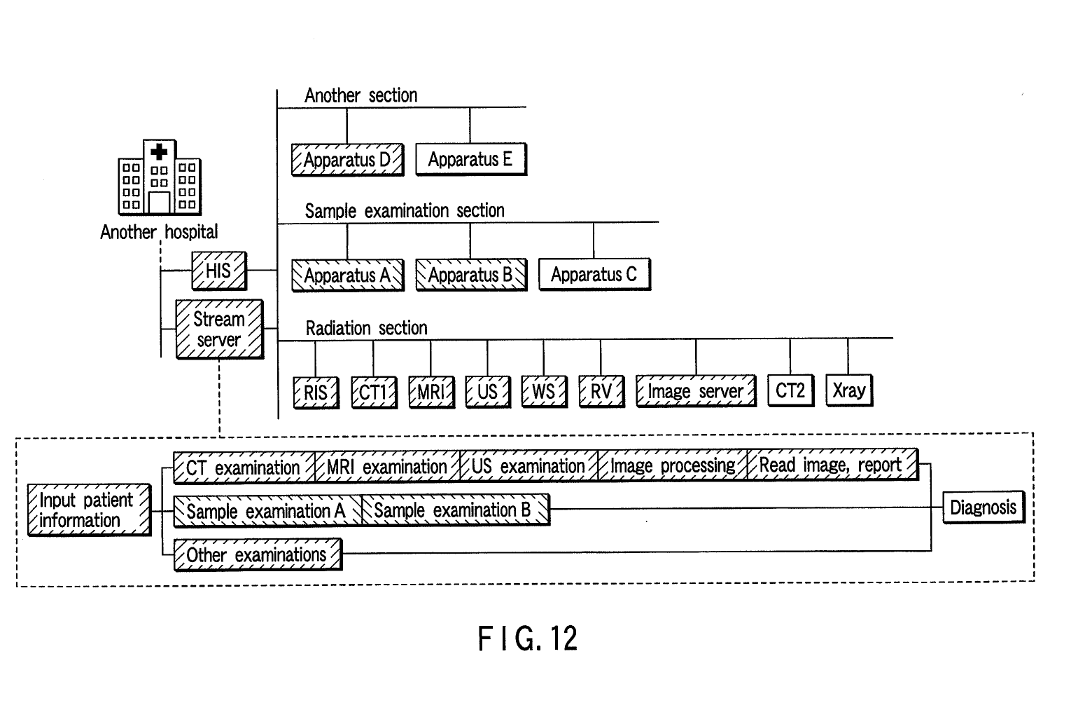

Moreover, the system may be constituted by disposing one stream control module in the hospital and controlling the stream of the whole hospital as shown in FIG. 12, or by disposing the sub module for managing the section as shown in FIG. 13. In either system, the following operation can be realized.

First, the patient comes to the hospital. The patient is registered by a receptionist, and an ID is issued. A past regular outpatient treatment history is also checked. If there is a regular outpatient treatment history, a link with a past patient's case record, past image, past report, and the like is set. Here, the stream is issued. Since any examination is not started, the patient's basic information (such as name, ID, gender, and date of birth) is inputted here. If data relating to the patient exists, it can be transferred.

An examination plan can be confirmed in the stream list in each examination section. In this case, the list is checked by each examination section or each doctor in a filtering manner. Of course, all the lists in the hospital or another linked hospital can be checked. Since the stream is managed by a central server, any apparatus connected to a LAN can be accessed. Another hospital can be accessed via the Internet or a limited network such as a WAN. At this time, since information relating to privacy, such as the patient information and diagnostic result is handled, strict security is required. In this case, an account is given to each operator, and an access right by password is applied. The account can access all resources. An access limitation is disposed for each manager account, grouped by areas such as the hospital, ward, and section; by job or rank classification such as doctor, engineer, nurse, clerk, or individuals, and a structure for preventing unnecessary access is devised, thus the patient information is protected.

An order of examination can be managed by a stream list. Therefore, a nurse checks the list, and introduces the patient to the examination doctor in order. Here, the list can be interrupted, or the order can be changed for an emergency patient. Of course, only a person who possesses authority can perform such an operation. The examination doctor refers to the past data (if any) from the stream. After the examination, further necessary examination, prescription of medication and injection, and the like can be inputted into an electronic case record or the stream, and indicated and recorded. The electronic case record can also be taken into the stream, or linked to the stream.

Here, a CT examination will be described. The doctor sends an order to the radiation section. For the stream, the content is selected from the template, or manually inputted or modified, and the order is issued. The content of the order is also automatically or manually sent to the radiology information system (RIS).

A simple instruction, for example, for a standard head scan, scan template in the CT apparatus, MPR or 3D preparation template, template of a fine process such as filming and archiving, and parameters used in the template can be instructed on the stream.

In the radiation section, the examination schedule is automatically or manually prepared in accordance with the information from the RIS or the stream schedule in the whole hospital, and executed.

The examinations scheduled using the CT apparatus are displayed on a list, and they proceed according to the list.

First, since the patient basic information and examination order information are already inputted in the stream in the patient/examination information input process, the content is checked, and the operator name or the prescription such as the contrast medium is automatically or manually inputted as the occasion demands. Since the input information is formed in the template and held, a selection processing is simple.

Subsequently, for the scan, when the scan plan is already selected in the requested section, the plan is confirmed. If there are no plans, the plan is selected, and the parameters are set.

Moreover, with a complicated scan, such as an image examination, abdomen image 3-phase scan, or a plurality of scans, realizing means, such as planning of all the contents in the scan plan, and combining of a plurality of scan processes are used.

Furthermore, a real-time CT fluoroscope, real-time 3D, MPR, 4D display, and the like can also be incorporated.

When the scan or the reconstruction ends, in accordance with the patient, site, and case, image check is performed. Also in this case, since a check method is preset in accordance with the scan content and operator, the method is used as it is, or changed, and the image is checked. Re-scan or reconstruction retry is performed based on the result. When the check operation ends, the operation is shifted to the next process by the “Next” button. As described above, in the stream, from issuance of the stream to the end, the flow of the stream can proceed in the order of processes in the stream.

In the next image processing process, image filter processing, MPR automatic preparation, and 3D automatic preparation are performed. An image filter type, MPR preparation condition (section angle, preparation position, preparation interval, image thickness, number of frames, and the like), and 3D preparation condition (rendering type such as volume rendering, MIP, X-ray display), opaqueness, color, preparation angle, preparation position, image thickness, number of frames, and the like) are defined beforehand as the template or a protocol, and held in the stream, or interactively selected by the operator in an introduction stage of the image processing process. Alternatively, the template or the protocol is automatically selected based on the patient/examination information already held in the stream. Alternatively, the information and image content are checked and automatically or manually adjusted, and the image is prepared. Here, instead of preparing the image, the preparation condition is only groped. In groping the preparation condition, for example, an operator 1 adjusts the image processing condition to a certain degree in the CT apparatus and workstation. Thereafter, an operator 2 can display or output the image on the same or another apparatus according to the conditions chosen by the operator 1. Here, in general, the operator 1 is a radiation section engineer, and the operator 2 is a radiation section doctor in many cases. Since the MPR or 3D image preparation sometimes includes a diagnostic action, the image is basically prepared by the doctor. However, the whole or a part of the image is sometimes prepared by the engineer for reasons such as time and operability. To solve the problem, in the present invention, the engineer uses the template or the protocol prepared or approved by the doctor to prepare the image. Alternatively, the engineer sets approximate preparation conditions then the doctor makes fine adjustments. This can be performed in a seamless manner in the same or another apparatus.

In this case, the prepared image or preparation condition can also be linked with the filming process, archiving process, and image transfer process.

As described above, in the stream, each ended process is automatically or manually shifted to the next process. Moreover, the process may automatically be started and executed by the preset template or protocol, or the operator can perform an interactive operation such as giving of an instruction each time the process starts.

As in image processing, the next filming process is automatically or manually executed in accordance with the template or the protocol defined in the stream or defined beforehand.

For example, the number of films, frame layout, frame size, luminance, and contrast are defined in accordance with the patient type, site, case, and the like, as required by the image reader doctor and requested section doctor.

These are automatically or manually set in accordance with the examination type and order, when the stream is prepared.

This also applies to the archiving and transfer processes. The number of images, image selection, image storage, image transfer address, and the like are also defined, and can be changed later.

Moreover, for a process requiring much time, such as the filming, archiving, and image transfer process, after the instruction is automatically or manually given, background processing can be performed.

Background processing has a processing mode such that the processing is simply performed in parallel with the foreground processing, with a reduced degree of priority as compared with the foreground processing, or only in response to the instruction given by the operator. Moreover, a detailed or schematic state of the background processing can be displayed.

The processes from input of the patient information to the image transfer in the CT apparatus has been described above. Depending upon the stream, there is also a case in which only some of the processes are performed or another process is incorporated.

After the image is outputted from the CT apparatus, the image is read via a film or a monitor. An example in which PACS is introduced, the image is read on the monitor in the workstation for reading the image, and a report is prepared will be described.

In the workstation for reading the image, the image reader doctor displays the stream list only of the data whose image is to be read. Here, as in the CT apparatus, the stream list is displayed as a schedule. Here, when the image reading process is selected, the prepared image is displayed, or the image is displayed in accordance with a previously-prepared condition. The image can thus be browsed.

Display conditions include luminance, contrast, filter condition, frame layout, modality, layout by grouping such as series, operation screen, operation form, and the like. Therefore, the image reader doctor can automatically or manually select a desired content and condition in accordance with the patient type, examination, site, and case.

Moreover, in the image processing process, the image can be displayed in accordance with the condition prepared by another operator. The image can promptly be seen under appropriate display and preparation conditions, and can further be adjusted.

Furthermore, the filming, archiving, and transfer process is performed. Here, the process is performed with respect to a key image extracted during the image reading. Of course, the process can also be performed with respect to all the images as the occasion demands.

Here, the key image is easy for the patient to read, and is transferred as a basis of diagnosis mainly to the requested section.

The report preparation is included in the image reading process, or performed in an independent process. In the image reading and report preparing process, information such as past information, past image, past report, and past case record can automatically or manually be obtained.

A report is manually written, typed, or dictated by the image reader doctor, and is finally sent to the requested section doctor.

The requested section doctor refers to the stream list and notes the progress of the examination. For example, only information of the performed examination requested by the doctor can be displayed. The examination may be requested to a plurality of sections. Usually, the diagnosis is not performed until all examination results necessary for the diagnosis are obtained. However, in an emergency case or another case, only the result of the performed examination is checked. Alternatively, the list can be seen by changing a list display condition.

When the stream or the diagnostic process is selected, the examination result is displayed. As in the image reading process, the desired condition can be automatically or manually selected.

(sub Stream)

A sub stream shown in FIG. 13 will be described. For example, in FIG. 12, the process is executed by a plurality of sections such as the radiation section and sample examination section in one stream. On the other hand, in FIG. 13, the stream can be managed independently by the radiation section, and only a portion executed by the radiation section upon request is managed by the stream control module of the radiation section in the main stream of the whole hospital. In the stream (work flow) of the whole hospital, a complicated branched or parallel operation is expected to be generated. FIG. 13 shows another example for realizing a complicated stream.

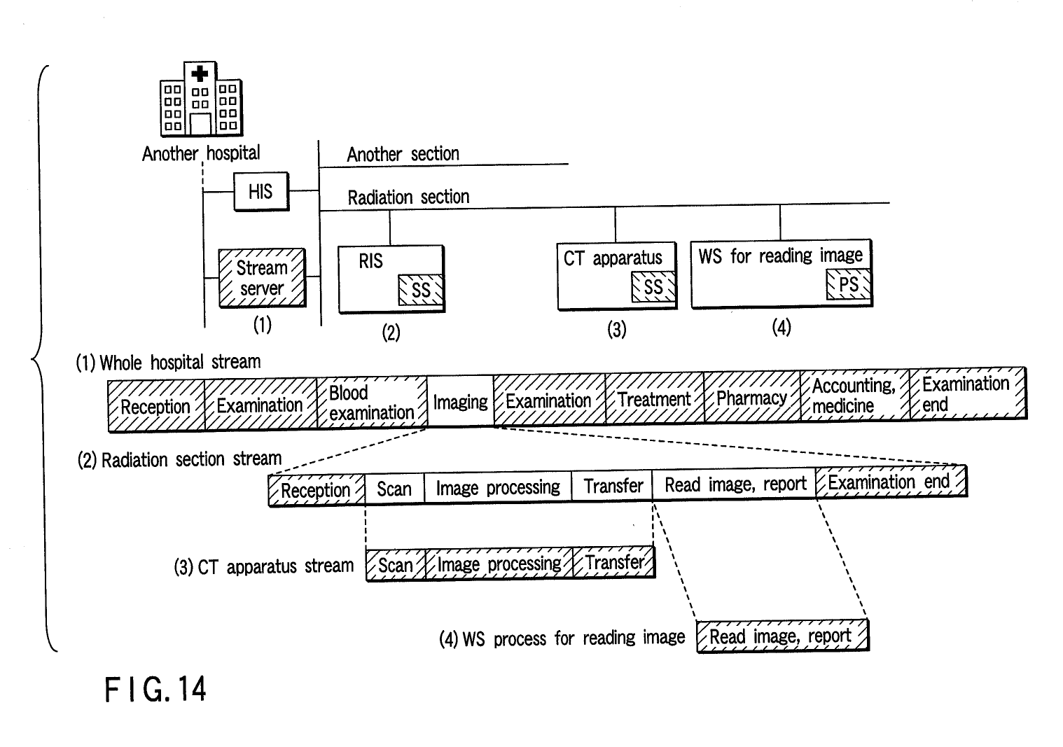

FIG. 14 shows an example in which the sub stream is controlled in the CT apparatus in the radiation section and the process is controlled in the workstation for reading the image. In the CT apparatus, the information is managed in accordance with the sub stream in the screen shown in FIG. 14.

### Example 2

An embodiment will next be described in which the present system is introduced into a hospital, and a series of medical works are performed with the predetermined medical action performed for the outpatient in accordance with the stream.

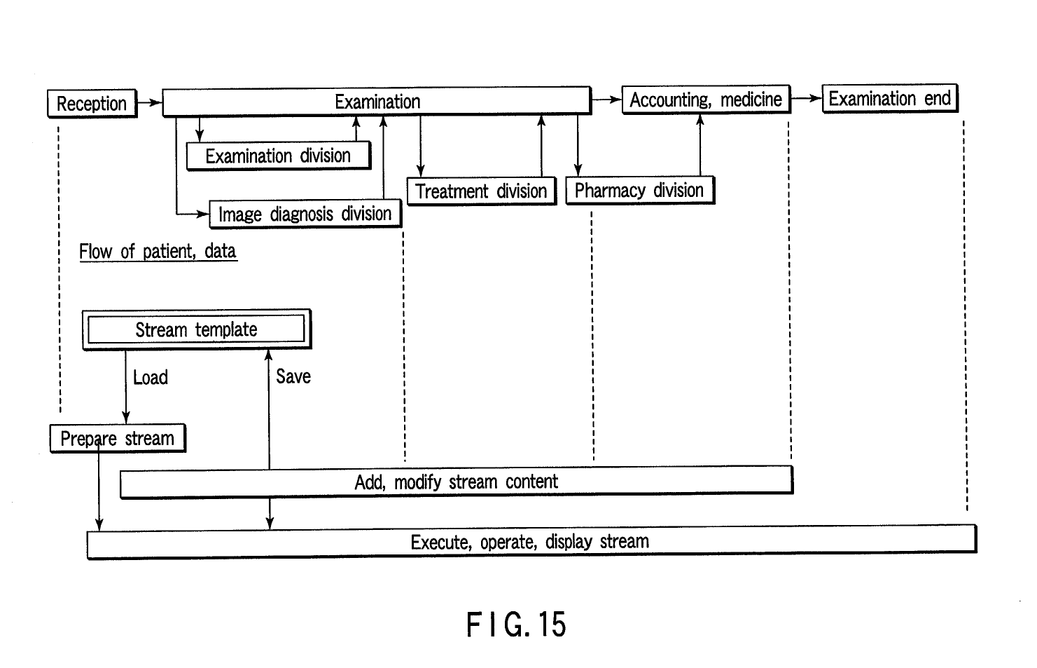

FIG. 15 schematically shows a flow of the outpatient and data in the hospital, when the present medical work management system is applied to the hospital and the medical work is performed in accordance with the stream. A concrete implementation content shown in FIG. 15 will be described hereinafter.

First, when the patient comes to the receptionist of the hospital, the stream is prepared. In this stage, only the patient input process is performed, and the subsequent flow is in a blank state. The operation can be performed by any terminal in which the stream server can be referred to. Basically, the HIS terminal is used.

For example, with a new patient, basic information, information of a health insurance card and the like, is input. On the other hand, if a returning patient is present, past examination data is referred to, and further a changed item is inputted.

Examination order and time scheduling is performed for each examination section based on the input content. In this stage, a default stream template in each examination section is applied for the subsequent stream. Basically, the scheduling is performed in the inputted order. However, in an emergency, etc., the schedule can manually be changed. When the stream is prepared in this manner, the subsequent medical work is executed in accordance with the schedule along the stream. The patient is then called to the examination room.

Subsequently, the nurse who called the patient uses a terminal close at hand to display the patient's schedule only of the examination section responsible, and performs reception. If necessary, the patient's information and past cast history can be selected from the stream and browsed.

Subsequently, the doctor executes an examination. When the examination ends, the doctor may order further examination or treatment on the stream. In this case, the stream template suitable for each examination order is selected and applied. As described above, the stream template is constituted by defining the whole works performed in a medical institution, or by defining a part of the stream after a certain process. For example, when a CT examination is ordered to the radiation section, the portion to be imaged, and the template suitable for the case are selected. If necessary, detailed instructions, such as parameters, can be inputted in the stream.

In an examination result waiting stage, the nurse can confirm the stage with the stream list, and introduces the next patient to the examination room. Moreover, the information is also displayed in a display board in a patient waiting room.

Subsequently, the patient goes to a sample examination section to receive blood and urine examinations. The situation of the patient who receives the examination can also be seen in the stream list in the examination division. An examination patient list having an ordered or reserved order can be seen with the stream list, and a content of examination to be performed is also displayed. When the examination ends, the end is inputted in the stream list.

Additionally, the examination section doctor can confirm the progress situation of the examination by glancing at the stream display as the occasion demands.

Subsequently, when the sample examination ends, the patient next goes to the radiation section for image taking. It can be judged with the stream in the CT examination room whether the patient to receive the CT examination has come to the waiting room or not. Basically, examinations are performed according to schedule. When the scheduled patient is late, or there is an emergency, this can be confirmed on the stream, and the examination order can be arbitrarily changed.

In actuality, a number of people are working in the examination room. Each of them can view the examination schedule with a terminal close at hand. After the examination is performed according to the stream, and completed, the display of the examined items changes. It can thus be confirmed that the examination has ended.

In image diagnostic processes such as image taking, image processing, image output, image reading, and report are performed. For these processes, the stream is prepared in accordance with process contents, and the processes are executed along the stream. In this case, a plurality of apparatuses such as an image pick-up apparatus, image processing apparatus, image reading apparatus, and report preparation apparatus are sometimes used.

The examination section doctor views the stream display if necessary, and can confirm the progress of the examination.

In this case, for example, the examination section doctor in another room can confirm with the stream whether all the ordered examinations have ended or not. An examined patient list can be displayed in the stream list, and the examination section doctor gives diagnosis based on the examination result in order of time of end or reserved time.

Additionally, if necessary, the examination result or image is explained to the patient. In this case, LIS or PACS is referred to by the operation on the stream, and the result or image can be immediately displayed. If necessary, an order is issued to a treatment room or a pharmacy division.

Moreover, examples of the content handled on the stream include not only the processing on the apparatus including a computer, such as image pick-up and image processing, but also treatments not using a computer apparatus, such as blood examination and injections. In the treatments, the terminal with the stream displayed therein (exclusive-use terminal, information processing terminal such as HIS, and the like) is used to artificially perform schedule management, browsing of process content, and input of process results.

For example, after an examination in the examination section, or an additionally required examination, a request for a concrete treatment content is artificially inputted and incorporated in the stream. A person in charge of the treatment confirms the situation in a treatment room, and executes the treatment (such as injection and drip transfusion) in accordance with this content. When the treatment ends, for example, the person in charge inputs treatment completion or “Next” in the examination stream via the terminal. In response to this input, the management on the stream advances, for example, to the next pharmacy process.

Additionally, a similar content is naturally not only reflected in the stream in the treatment room but also in other processes of other sections, such as a pharmacy section and accounting section. Moreover, the information may be inputted into the stream control module from the terminal in each section in any mode. For example, the information may be inputted via a keyboard, mouse, and the like disposed at the terminal, or by reading an ID card, bar code, and the like for each patient. Particularly, patient identification by the ID card is effective in that the patient is prevented from being mistaken, and the task of data input of patient/examination information into the apparatus can be avoided. The identification may be used simply in identifying the patient. Moreover, the input of the ID can also be used as an input for starting the treatment on the patient.

Finally, accounting, medicine receiving, and next reservation will be described. The patient makes payment and receives medicine. This information is also inputted in the stream. If necessary, a reservation for the next examination is made. The default stream is prepared for the next examination. In this stage, the stream generated during reception turns to an end status.

### Example 3

Another embodiment will next be described in which the medical work relating to a plurality of patients is executed in parallel (see FIGS. 4, 5) in an example of CT examination.

In the CT examination, an ability of processing such as the reconstruction, image processing, and filming cannot catch up with an enhanced property of a latest scanner, and check and adjustment operations have to be performed with respect to many images. Therefore, a time for the process performing on the console tends to increase.

When a series of processes of CT examinations are performed in series, the examination throughput is reduced. To solve the problem, a plurality of examinations are sometimes performed in parallel.

For example, when a certain sample (patient) comes into/out of the examination room, and scan preparation is performed, the image processing or filming of the scanned sample (patient) previously is performed beforehand. In this case, when the scan and filming processing is manually performed in parallel, either one or both of the respective operation/display screens can be displayed during the processing. When the screens are displayed one by one, the scan or the filming can be selected with the stream in the stream list. When both screens are displayed, the stream or the operation/display screen can be selected. In this case, the scan screen can be distinguished from the filming screen by color, icon, ID display, and the like.

Moreover, when the filming operation is not ended within the time allotted, a number of filming operations can sometimes pile up. This can be confirmed with the stream list, when the state of the filming process of the left stream is unfinished.

Furthermore, in a CT apparatus, a plurality of consoles and WSs are sometimes used with respect to one scanner for reasons such as enhancement of the throughput. In this case, the patient/examination information input, scan, reconstruction, and image check are performed at console 1, and the image processing, filming, archiving, and image transfer are performed at console 2. In this manner, the processes are allotted to the respective consoles.

In this case, an exclusive control can be achieved so that the process or the stream being performed in one apparatus cannot be selected in another apparatus. Moreover, the apparatus, operator, and progress of the processing can be checked.

### Embodiment 4

An embodiment will next be described in which the present medical work management system is applied to a plurality of hospitals, and a composite medical work is executed along the stream over the plurality of hospitals.

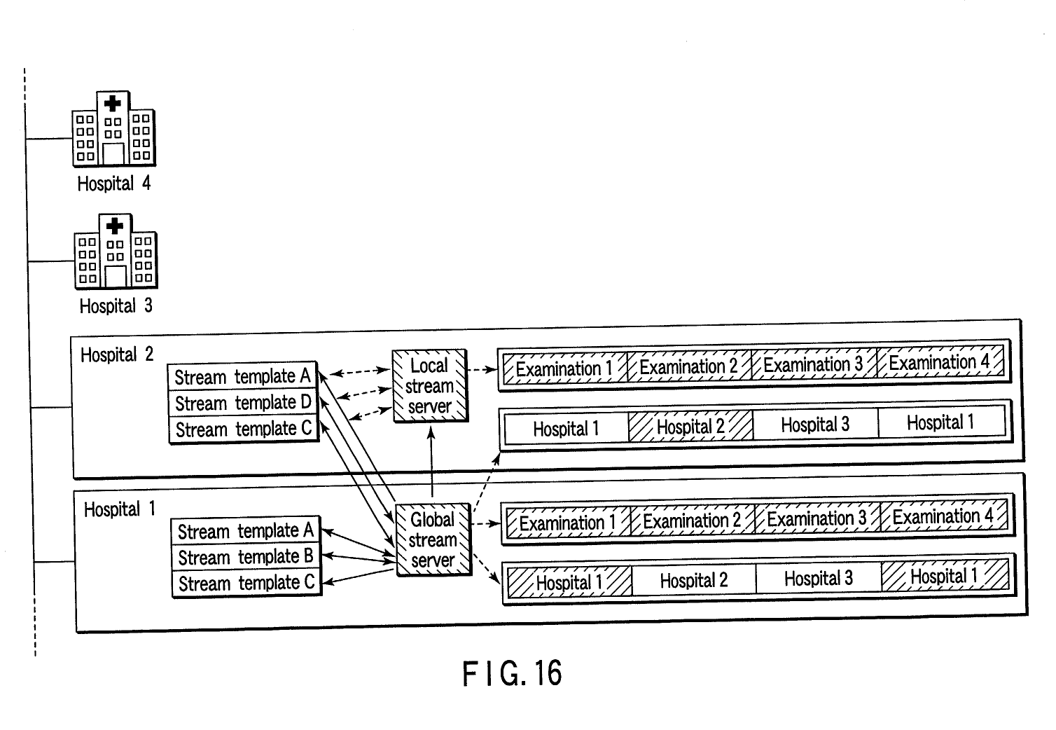

FIG. 16 shows an example in which the present medical work management system is applied to the plurality of hospitals. In the system, template management and stream management are performed among the hospitals. In the present system, a global stream control module is disposed in one hospital, and local stream control modules are disposed in other hospitals.

When the template management is shared among the plurality of hospitals, the respective apparatuses on the network installed in the respective hospitals are read from the global stream control module, or registered. Moreover, in order to solve problems in network connection, and backup the global stream control module, the information is periodically copied also into the local stream control module. In this manner, the local stream control module has functions for: securing a local performance; backing up the global stream control module if a problem occurs in the connection; and backing up and holding the data of the global stream control module.

When the stream is passed through the hospitals, the global stream control module controls and manages the stream extending over the plurality of hospitals.

Additionally, the system shown in FIG. 16 indicates a relation of the plurality of hospitals, but the constitution of the system can also be applied to a relation among a plurality of sections or wards in one hospital. That is, a similar constitution can also realize a system in which the global stream control module is disposed, for example, in the HIS section and the local stream control modules are disposed in the respective sections.

According to the aforementioned constitutions, the following effects can be obtained.

First, the flow of patients and examinations can be operated as the stream in the whole system. Therefore, a unified operability can be provided in various apparatuses.

Secondly, since the stream can be developed in the whole network system, a work flow extending over the plurality of apparatuses, and schedule can easily be managed and indicated.

Thirdly, when the stream is displayed in the list, a lateral flow of examinations, or a “work flow”, and scheduling of a plurality of patients and examinations as a longitudinal flow can collectively be controlled, displayed, and operated. Since the longitudinal and lateral flows are generally managed, reduction of mistakes, enhancement of the throughput, and a decrease in unnecessary operations can be expected.

Fourthly, when the stream is applied to a plurality of apparatuses, the patient information input operation may only need to be performed once, in many cases. This can be expected to reduce unnecessary operations, and mistakes.

Fifthly, when the stream and process are directly selected, the desired processing can be performed. Therefore, the reduction of operation time and errors, and simplification of obtaining of the operation method can be expected.

The present invention has been described above based on the embodiments, but any person skilled in the art can develop various changes and modifications within the scope and spirit of the present invention. It is understood that these changes and modifications fall within the scope of the present invention, and the present invention can be variously modified without departing from the scope.

For example, the present invention can variously be modified without departing from the scope as follows.

The above-mentioned system or the business management approach can also be realized based on the storage medium which records the program for the system concerned etc., and from which computer readout is possible, or the transmission medium which transmits the program concerned. In addition, if the storage medium from which computer readout is possible points out all the media that can memorize the program which performs the above-mentioned means to the computer, the form has for example, the volatile medium, the non-volatility medium (the optical disk, the magnetic disk, magnetic optical disk), the transmission medium (the coaxial cable, the copper wire, optical fiber), etc. and the same function is achieved, it will not be the meaning limited to these media. Moreover, the transmission medium may spread the acoustic wave or the light wave which is generated between the electric waves and performs infrared data communication.

As described above, there can be realized a medical work management system able to quickly provide information by which the flow of the medical works can appropriately and easily be grasped, in a global system easily operable by a user, for a plurality of apparatuses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system to be connected via a network to a plurality of medical systems installed in a medical institution, configured to manage various works performed at the medical systems, said system comprising:
a memory which stores information items relating to work processes performed in the medical systems, each item representing the sequence and conditions of one work process relating to one patient or one medical examination;
an information-updating processor which updates the information item stored in the memory to one that represents the present state of the work process; and
a transmitter which transmits display information to the medical systems through the network, the display information causing the medical system to display the information items updated on the present state of each of the work processes in such a display mode as to represent the present state of each of the work process relating to one patient or one medical examination.

2. The system according to claim 1, wherein each medical system comprises:
a display device which displays states of the work processes being performed at any medical systems;
a process-selecting device which is operated to select each of work processes displayed by said display device; and
a processor that performs the work process selected by operating said process-selecting device.

3. The system according to claim 2, which further comprises: an input device which is operated to input data for updating the sequences of the work processes displayed by the display device, and in which said information-updating processor updates the information items stored in said memory in accordance with the data input from said input device.

4. The system according to claim 2, wherein said display device controls the number of steps of each work process which is displayed and constitutes each of the information items on the basis of a preset condition.

5. A system for managing various works in a medical institution, which comprises a plurality of medical devices or terminal devices which are connected to a network and a host computer which controls, via the network, works performed by using the medical devices or terminal devices,
said host computer comprising:
a memory which stores information representing sequential steps of at least one process defining a prescribed work relating to medical service and conditions in which the medical devices or terminal devices are to perform the prescribed work;
an information-selecting device which selects and reads work information about a work performed on a patient, from said memory in accordance with diagnostic data input;
a processor which controls, in accordance with the selected work information, the sequence of a process, which is defined by the work information about the work performed on the patient;
a controller which controls the medical devices or terminal devices as said processor controls the sequence of a process; and
a transmitter which transmits the work information selected by said information-selecting device and representing the state of the work being performed, to the medical devices or terminal devices,
wherein said medical devices or terminal devices comprise display devices, respectively, which display the work information at the same time.

6. The system according to claim 5, wherein each of said medical devices or terminal devices further comprises an input device which is operated to input alteration information configured to update the work information displayed by said display device;
said host computer further comprises a receiver which receives the alteration information from said input device, through the network; and
said processor updates the work information in accordance with the alteration information received by said receiver.

7. The system according to claim 5, wherein said display device controls the number of steps of each work process which is displayed and constitutes each of the information items on the basis of a preset condition for each of the medical devices or terminal devices.

8. A system for managing various works in a medical institution, which comprises a plurality of medical devices or terminal devices which are connected to a network and a host computer which controls, via the network, works performed by using the medical devices or terminal devices,
said host computer comprising:
a memory which stores information representing the sequential steps of at least one process defining a prescribed work relating to medical service and the conditions in which the medical devices or terminal devices are able to perform the prescribed work;
an information-selecting device which selects and reads work information about a work performed on a patient, from the memory in accordance with diagnostic data input;
an information-updating processor which updates the work information to one representing the work now being performed in each of the medical device or terminal devices, in response to information that represents the present state of each medical device or terminal device and is transmitted from each medical device or terminal device connected to the network; and
a transmitter which transmits the work information updated by said information-updating processor to said medical devices or terminal devices, and
each of said medical devices and terminal devices comprising:
a display device which displays the sequence of the work process represented by the work information selected by said information-selecting device and transmitted from said transmitter;
a controller which controls a process defined by the work information; and
a transmitter which transmits information representing a state of the work being performed on the patient, to said host computer through the network.

9. The system according to claim 8, wherein each of said medical devices and terminal devices further comprises an input device which is operated to input data for updating the sequences of the work process displayed by the display device, and in which the information-updating processor updates the sequence of the work process in accordance with the data input by said input device.

10. The system according to claim 8, wherein the number of steps of each work process, which is displayed by said display device, is controlled by a condition preset for each of said medical devices or terminal devices.

11. A method of managing various works performed at medical systems installed in a medical institution, by using a system connected to the medical systems via a network, said method comprising:
updating information items relating to the work processes performed in the medical systems, each of the information items corresponding to one patient or one medical inspection and representing the sequence and conditions of the work process; and
transmitting display information to the medical systems through the network, the display information causing the medical system to display the information items updated on the present state of each of the work processes in such a display mode as to represent the present state of each of the work process relating to one patient or one medical examination.

12. The method according to claim 11, further comprising: displaying the state of the work process being performed at any medical system that have received the display information, and
performing a corresponding process in response to selection indication to each of the displayed work processes.

13. The method according to claim 11, wherein the information item representing the sequence of the work process is updated when the sequence is changed,.

14. The method, wherein the number of steps of each work process, which is displayed, is controlled by a prescribed condition.

15. A method of managing various works performed by a plurality of medical devices or terminal devices connected to a network, said method comprising:
changing the sequence of a work process which is defined by work information relating to one patient or one medical inspection, in accordance with work information which includes an information item representing the sequential steps of at least one process defining a prescribed work relating to medical service and an information item representing the conditions in which the medical devices or terminal devices are able to perform the prescribed work;
controlling the medical devices or terminal devices in accordance with the sequence of a work process, thus changed; and
displaying, at each of the medical devices or terminal devices, the work information which represents the state of the work process being performed.

16. The method according to claim 15, wherein the information item representing the sequence of the work process is updated when the sequence is changed,

17. The method according to claim 15, wherein the number of steps of each work process, which is displayed, is controlled by a prescribed condition.
